(19) United States
(12) Patent Application Publication
(10) Pub. No.: US 2008/0108025 A1
(43) Pub. Date: May 8, 2008

(54) SYSTEM AND METHOD FOR CREATING LEARNING MEDIA ON THE INTERNET

(76) Inventor: Bryan Menell, Austin, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 11/837,914

(22) Filed: Aug. 13, 2007

Related U.S. Application Data
(60) Provisional application No. 60/822,932, filed on Aug. 19, 2006.

(51) Int. Cl. G09B 19/00

(52) U.S. Cl. 434/118

(57) ABSTRACT

A method for creating learning media, which includes providing a graphical user interface, using the graphical user interface for receiving user content from a user. The user content is separated into user content data and user content metadata. A software engine and a template are used to create learning media, which is then published. The user content metadata provides the context for the user content data. The metadata is interpreted by the software engine to determine where various components are to be positioned in the learning media, based on pre-programmed learning media format information included in the template.

This application claims the benefit of provisional patent application 60/822,932 entitled “A SYSTEM AND METHOD FOR CREATING LEARNING MEDIA ON THE INTERNET,” by Bryan Mennell filed on Aug. 19, 2006, which is hereby incorporated by reference.

### FIELD

This disclosure relates to a system and method for allowing users to create media in a learning format, assign legal rights to it, make it available in a marketplace, sell it, and combine it with other learning media.

### DESCRIPTION OF THE RELATED ART

The e-Learning field encompasses a vast array of computer based training (CBT) programs. CBT encompasses a wide range of software and services offering education and training on the computer. It may be Internet based training, CD-ROM training, or streaming video training on a computer. CBT includes tutorials, drill and practice sessions, simulations, testing and generally offers feedback.

Defining aspects of CBT are high development costs, labor intensity and a need for wide-ranging skill set. Because of the complexity of a CBT program, a team of several members is typically assigned to build it. Costs vary, in the e-Learning industry, based on the amount of video, quality of the video, flexibility of navigation, tracking requirements and a multitude of other complex interactions. These types of technology based training (TBT) incorporate the entire spectrum of electronic delivery through a variety of media including Internet, LAN or WAN (intranet or extranet), satellite broadcast, audio or video media, interactive TV, or CD-ROM. TBT includes both CBT (Computer Based Training) and WBT (Web Based Training).

A typical CBT may be divided into a three-tier hierarchy, as depicted in FIG. 1. This includes the interface (which are the toolbars, navigation buttons, etc.), the data (text, graphics, hyperlinks, etc.) and the logic (the component responsible for intelligently sharing data between them).

A problem with the prior art is that all of these layers are on the same level, as illustrated in FIG. 2. In the most basic HTML course, there are statically linked pages, wherein each page contains information pointing to next and previous pages. Furthermore each page has a replicated interface, which is a copy of the code for the global navigation and graphical layout and a static layout, which encompasses every element on the page and requires the manually including of text, graphics, interactions and navigational elements. Additionally, a basic HTML course has duplication of content via a storyboard, which is not tied, in an automated way, to the contents of the course.

It is readily apparent that a basic HTML course is not easily created. Every page from the storyboard must be copied and the programmer must make layout decisions, screen by screen. The navigation links on every page must be updated and thoroughly tested. Each interaction must either be created from scratch or copied from existing code and then customized to fit the current project.

Moreover, a basic HTML course's subject matter is not easily updated by an expert or instructional designer due to the fact that both the storyboard and the course require updating. These difficulties also extend to the software programmer, because the adding or moving of a page requires updating the links on the next and previous pages as well. Changing global controls or adding new features requires, at best, a complicated search-and-replace operation, and at worst it requires manually editing each page.

For all intents and purposes the content and course are not easily reused or repurposed into another course, or as a subset of another course. If someone were building a slightly different course and wanted to re-use a module, they would have to replace all of the hard-coded navigation and modify the layout in every page to match the look and feel of the new course. If the layout in the new course is different, and the content needs to be re-arranged, then the author basically must create each page from scratch.

The prior art is deficient in that it does not provide for the implementation of a basic HTML or e-Learning course on multiple tiers, by separating the interface, business logic and data components comprising the offering.

The prior art is further deficient in that it does not provide for the reusability of business logic and data.

The prior art is further deficient in that it does not provide for non-programmers to be able to manipulate content without having extensive backgrounds in programming the business logic and interface aspects of an e-Learning or similar type course.

There is a need for a means to implement TBT on multiple tiers with transportability of the business logic and data between TBTs.

There is a further need for a means to atomize content into its most basic units and facilitate the content's transfer and portability.

There is a still further need for a means to standardize templates and styles to eliminate the need for the casual user to construct e-Learning courses without the need of advance programming skills and knowledge.

### SUMMARY

In accordance with the present disclosure, a method for creating learning media is provided. The method for creating learning media includes providing a graphical user interface. The graphical user interface is used for receiving user content from a user. The user content is separated into user content data and user content metadata. A software engine and a template are used to create learning media, which is then published. The user content metadata provides the context for the user content data. The metadata is interpreted by the software engine to determine where various components are to be positioned in the learning media, based on pre-programmed learning media format information included in the template.

### BRIEF DESCRIPTIONS OF THE DRAWINGS

The features, nature, and advantages of the disclosed subject matter may become more apparent from the detailed description set forth below when taken in conjunction with the drawings in which like reference characters identify correspondingly throughout and wherein:

FIG. 1 depicts basic components of an e-Learning HTML course;

FIG. 2 depicts configuration of the basic components of the e-Learning HTML course of FIG. 1;

FIG. 3 depicts a method for abstracting learning data from the presentation layer;

FIG. 4 depicts interactive templates of an aspect of the present disclosure;

FIG. 5 depicts an interactive template of an aspect of the present disclosure;

FIG. 6 depicts a sample activity of an aspect of the present disclosure;

FIG. 7 depicts a high level overview of central aspects of an embodiment of the present disclosure;

FIG. 8 depicts a method by which display techniques inherit attributes of a chosen display style or skin;

FIG. 9 depicts aspects of the overall concept of the present disclosure;

FIG. 10 depicts a graphical user interface of an embodiment of the present disclosure;

FIG. 11 depicts the concept of NanoLists, which is a collection of learning media elements;

FIG. 12 depicts aspects of a welcome tab and related sub-tabs;

FIG. 13 depicts aspects of an Explore tab of the graphical user interface of the present disclosure;

FIG. 14 depicts aspects of a search sub-tab of the Explore tab of the present disclosure;

FIG. 15 depicts aspects of an Advance search sub-tab of the Explore tab of the present disclosure;

FIG. 16 depicts aspects of a Nanolist tab and its associated sub-tabs of the present disclosure;

FIG. 17 depicts aspects of a My Account tab and its associated sub-tabs of the present disclosure; and

FIG. 18 depicts a system level overview of the operating system and associated software and hardware of an aspect of the present disclosure.

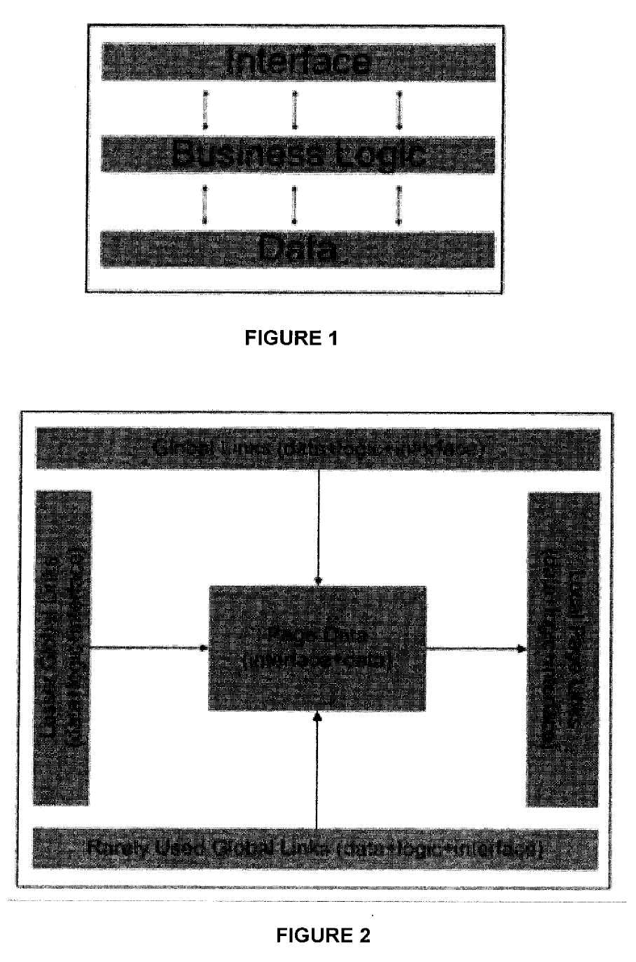

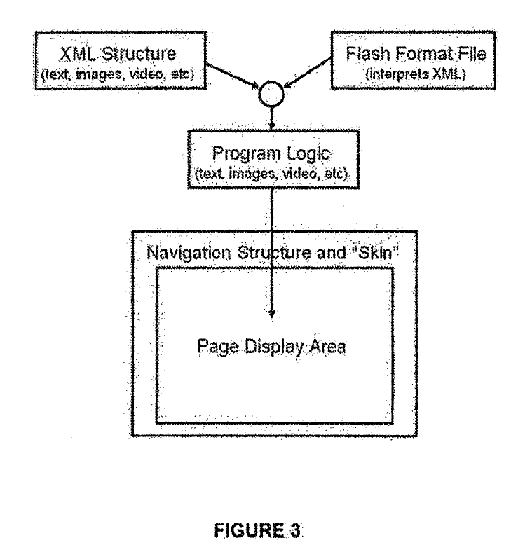

### DETAILED DESCRIPTION OF THE SPECIFIC EMBODIMENTS

The following description is not to be taken in a limiting sense, but is made for the purpose of describing the general principles of the disclosure. The scope of the disclosure should be determined with reference to the claims.

The present disclosure overcomes the problems of the prior art by completely abstracting the data from all layout information. The present disclosure contemplates the use of XML to accomplish this task, but is not limited to XML as any data structure will provide similar if not the same results. The data should be present as unbiased data, therefore facilitating and enhancing its transportability.

This metadata provides the context, which is interpreted by the software engine, which determines where the text, graphics, audio, video and other components are to be positioned. With this methodology in place, the content may be quickly and easily manipulated without the need for extensive programming and layout of the subject matter.

The present disclosure contemplates the use of style sheets or templates with the content, thereby providing the user with the ability to change the style if there is a need to change layout, size, or color in the course without the need of having to manipulate the underlying data.

The present disclosure also contemplates the use of templates in the area of interactions between the data and user. By building templates that provide certain functionality, i.e. interaction between the user and the data, it alleviates if not totally eliminates the need for the user to have program interactions into the data set.

The present disclosure further employs interactive templates as a means to facilitate the separation of content and design elements. With regard to an e-Learning course, a template may mean many different things and may be applied on many different levels. For instance, background and positioning templates may be employed, wherein everything around the content is removed and placed in a separate tier. By utilizing this approach, the present disclosure places all of the data, i.e. content, in a file or files by itself, thereby creating a multi-tier application.

Although in the present disclosure the data has been abstracted to a separate file or files, there is still a significant amount of program logic dictating how the data should be displayed, interacts with other data and is associated with other data via metadata and stored in the page.

Extensible Markup Language (XML) is a general-purpose markup language, capable of describing many different kinds of data. In other words, XML is a way of describing data. An XML file may also contain data. XML is a wide standard for encoding structured information and is contemplated by the present disclosure as the most efficient and logical means for handling the data.

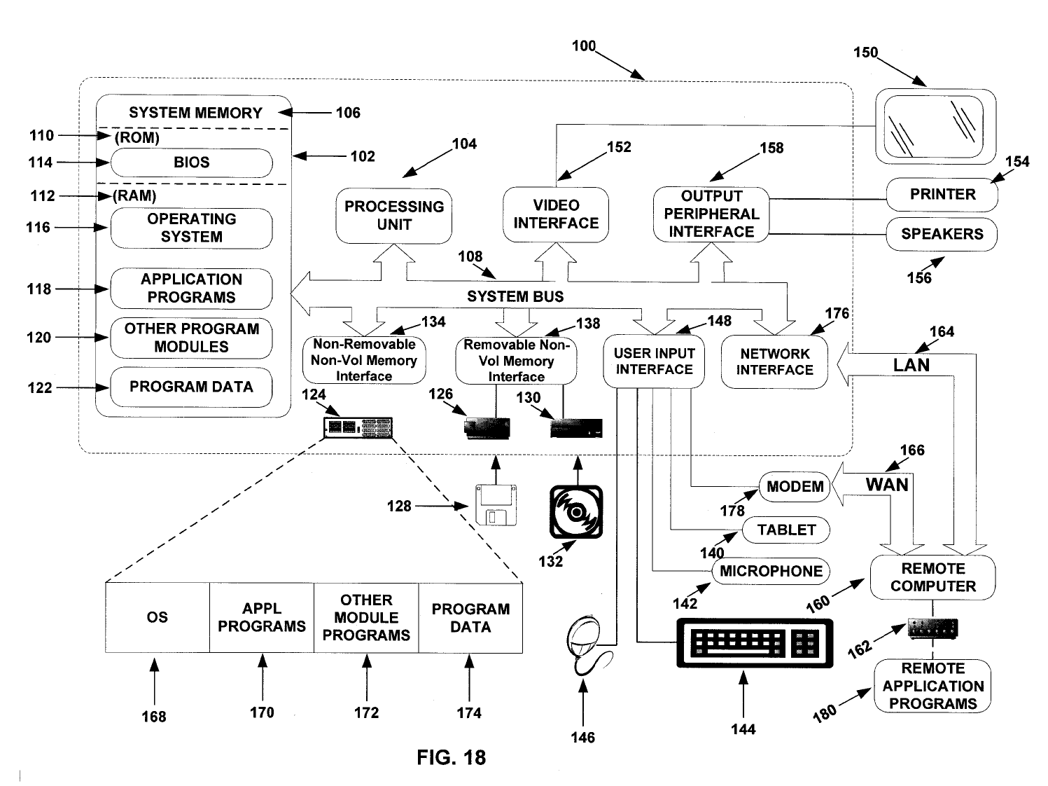

Although XML is contemplated by the present disclosure and is the most logical choice for abstracting the data, any data structure exhibiting the general characteristics (un-biasing of the data) of XML may be utilized without departing from the scope of the present disclosure. Therefore, the metadata associated with the data provides for the context of the data and is utilized by the style and template software engines to layout the content as designed. FIG. 18 shows how the abstracted XML data is matched up with a Flash template where the program logic displays the information to the user in the display area.

Interactive templates may also be employed by the present disclosure to communicate with a learning management system (LMS). A learning management system (LMS) provides the platform for an online learning environment by enabling the management, delivery and tracking of learning. For instance, a Shareable Content Object Reference Model (SCORM) is an XML-based framework used to define and access information about learning objects/applets so they may be easily shared among different LMSs.

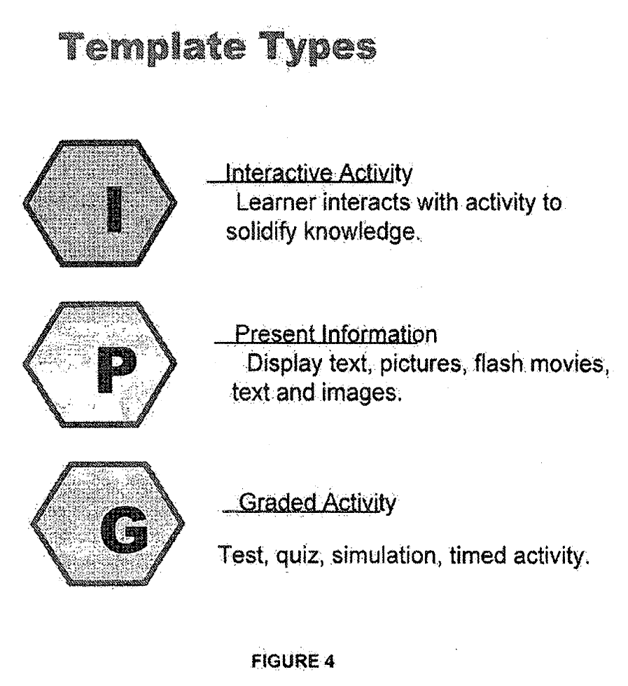

As depicted in FIG. 4, templates may be of a multitude of types. For instance, a template may be an interactive template, wherein the learner interacts with the activity to solidify and gain knowledge; a present information template, which displays text, pictures, flash movies, images, etc; or a graded activity, such as a test, quiz, simulation or timed activity.

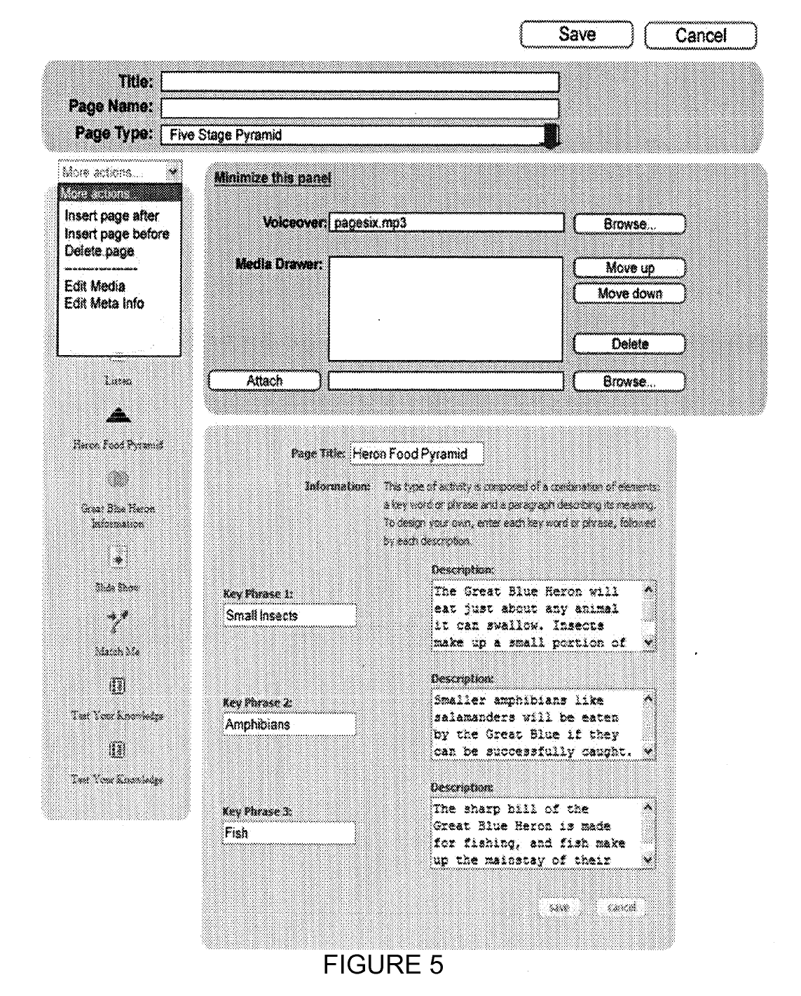

FIG. 5 depicts an interactive template and illustrates the ease of use of the present disclosure. In this example, the owner/creator has created an applet Heron food pyramid. As may be seen in FIG. 5, the user simply enters the content and creates the associations between the content. The user has navigation buttons to direct the storyboard aspects of the course at his/her disposal. The user may select true/false type questions, matching exercises, Venn diagrams, multiple choice questions etc. all at the users fingertips.

The relationships of the particular aspects are entered into dialogue boxes and further definitions and content are mapped to these key phrases and are entered via a description or dialogue box. The entering process for the user is basically point-and-click in nature. It does not require the user to perform any programming whatsoever. In this example, once the user has completed the course it is published so that the target audience may access it at any time. The creator/owner may invite members to view and critique the content, style, utility, effectiveness, etc.

The user may place restrictions on the content, in that the user may specify that the material is copyrighted material or exercises moral rights. The user may make the material for private use only or limited use only and further may offer the course or any templates created as freeware or shareware or may require others in the community to take a license or pay a fee to utilize the content and/or template.

If the user can create a PowerPoint presentation, the user can create an object/applet (i.e. course or presentation) that gets published at a standard web address. Where PowerPoint provides templates for visual elements and page layout, the present disclosure provides interactive templates for information display, pre-programmed interactive learning activities, and assessments like multiple-choice tests. Configuring the template is done through a software wizard employing multiple subroutines, so no programming is ever required by the user.

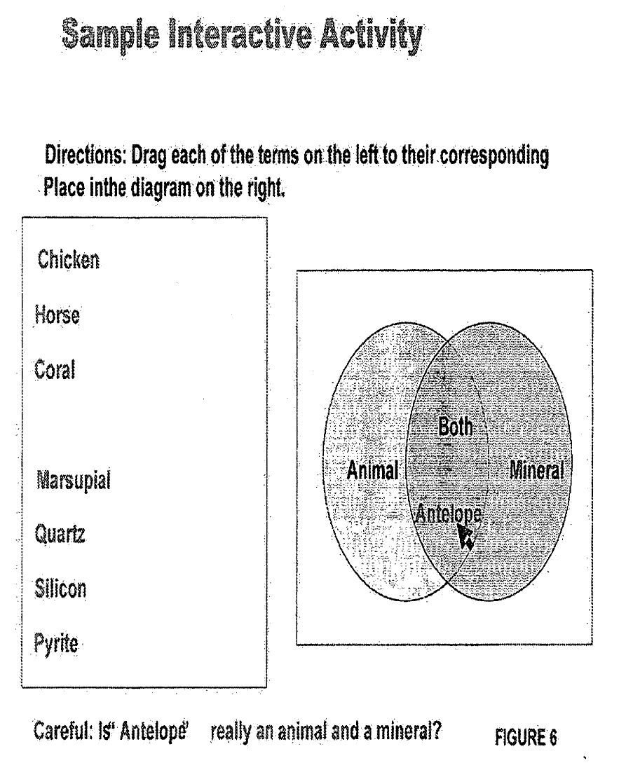

An aspect of the present disclosure is depicted in FIG. 6. FIG. 6 illustrates a sample interactive activity, whereby the user drags each of the terms from the left box to their corresponding place in the Venn diagram on the right. Testing software reviews the response, in the instance the selection of a term and its placement in the diagram, and provides the user with feedback as to whether the selection is right or wrong. In a further aspect of the present disclosure, if the user does not score above a predetermined threshold level, the programming will provide the user with a pop-up review section, where they may drill the subject matter before retaking the test or moving on to the next section.

Additionally, the interactive template via its attendant programming may provide the user with reasons as to why the errant selection was not correct; thereby further enhancing the learning experience. In compliance type situations the outcome and score would be recorded and reported to the appropriate personnel for further action.

Aggregation engines/modules and reconstructor engines/modules are software programs designed to syndicate and distribute media created on micro-platforms. Aggregators take preference and context information and aggregate microchunks. Reconstructors build individualized casts of media for connected consumers.

The present disclosure allows users to create learning, rate learning they have seen, recommend learning they have seen, subscribe to an RSS feed to be notified when it gets updated, aggregate a list of learning objects into a group (created by the user or anyone else), or use an existing learning object as a starting point for a new learning object.

For users who want to keep their information private, the system is like sending out an Evite. Submit a list of users that need to take this learning, and we will notify them, save their test scores, and report back to you on who took it, how they scored, what date and time they took the course, and other pertinent compliance related information. We may even remind them by a certain date that they have not taken the required learning yet.

As previously stated, to produce a user created object, the user has access to a variety of templates to aid them in this endeavor. The templates may display information, assess the learner, or provide an interactive learning activity. These templates are all pre-programmed and require only a software wizard to configure them. There is no programming of any kind required to create an engaging and interesting interactive activity. Normally it would take a Flash programmer several hours to conceive, design, create, and test such an activity. With the present disclosure it takes less than a minute to configure.

Moreover, since the user may access other similar or on-point presentations, the user may utilize aspects of those presentations/courses to populate their own presentation or simply create a playlist or course list from preexisting public and private domain presentations.

While the user is the owner of the object or applet created, unless access is denied to other users, those users are capable of utilizing the content, the templates and styles without restriction.

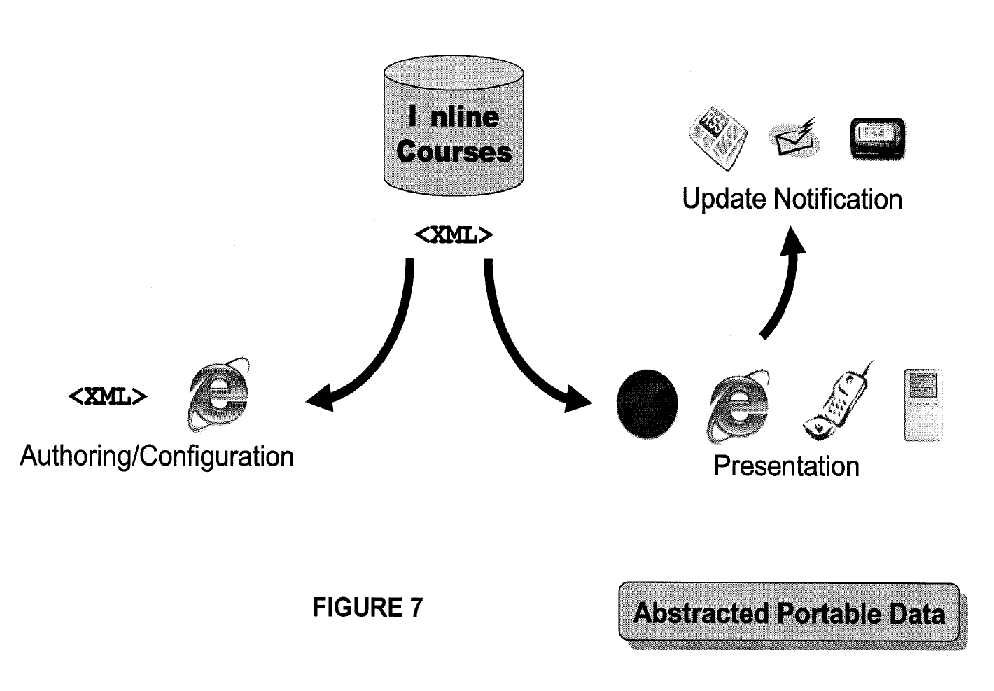

FIG. 7 depicts a basic high-level configuration of an aspect of the present disclosure. The online courses are stored at a remote site (although it may be hosted at a private site) as an XML or similar type format. The user accesses the remote site via the Internet in this example. The abstracted portable data is manipulated into presentations, courses, etc. and published by the remote site. Other members of the community may be notified, at the creator's discretion, by various well-known means.

As previously stated, an aspect of the present disclosure requires only configuration without programming. In order to facilitate this aspect, a template's application program interface (API) is open to the community to create new and useful templates. An API is a set of routines, protocols, and tools for building software applications and makes it easier to develop a program by providing all the building blocks a programmer needs.

A typical programming language for creating templates and styles is Adobe Flash or simply Flash. Flash refers to both the Flash Player and to a multimedia-authoring program used to create counter for the Adobe Engagement Platform (such as web applications, games and movies) and is a client application available in most dominant web browsers. It features support for vector and raster graphics, a scripting language called ActionScript and bi-directional streaming of audio and video. Flash is commonly used to create animation, advertisements, various web-page components, integrate video into web pages, and more recently, develop rich Internet applications such as portals.

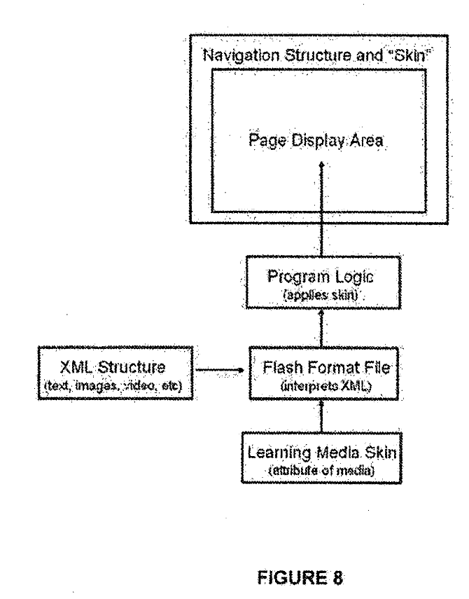

FIG. 8 depicts how each learning media object has many attributes including a style sheet type or “skin” that contains visual look and feel information. The Flash template and the accompanying XML data inherit the skin information and will change their appearance based upon the skin type.

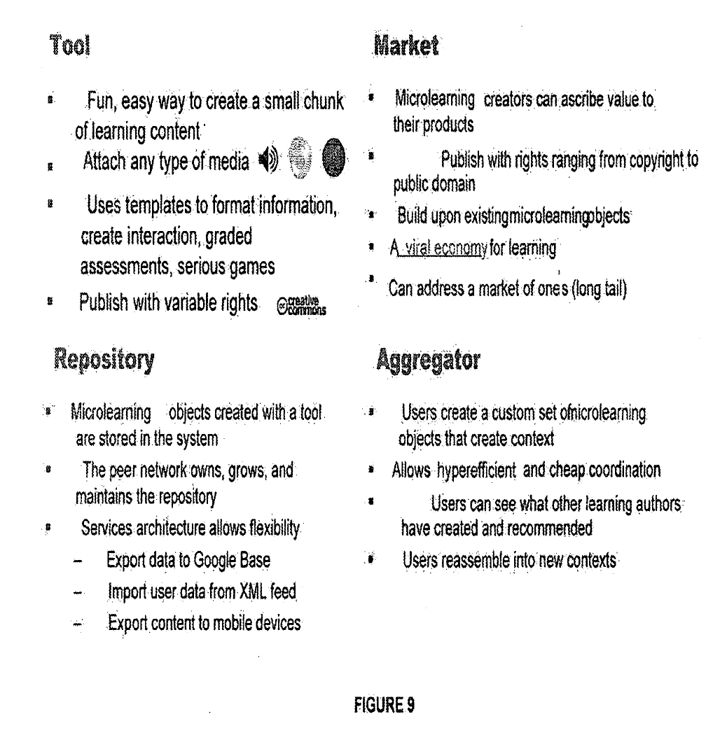

FIG. 9 depicts aspects of overall concepts of the present disclosure, illustrating aspects such as tools, repository parameters, market parameters and aggregation.

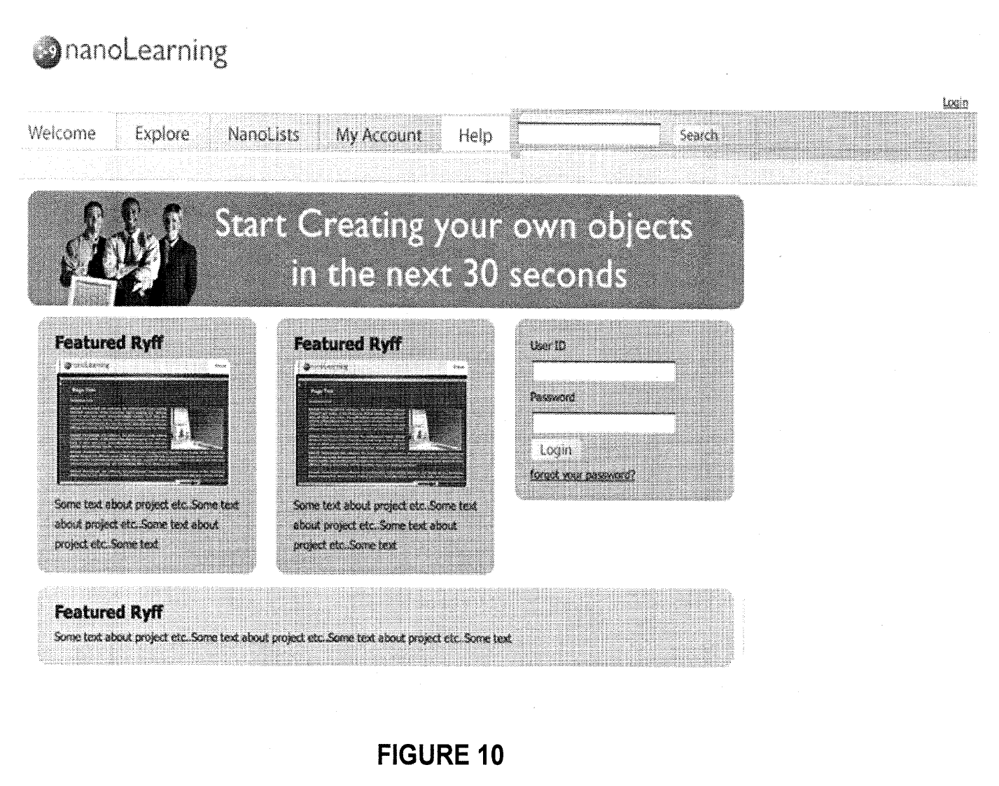

An example of the general access to the aspects of the present disclosure will not be explored with reference to FIGS. 10-18. FIG. 10 depicts a basic graphical user interface (GUI) of the present disclosure. The user once logged in is directed to this welcome page. The user may then explore the site and objects/applets created, create a nanolist, access account information or access the help menu by clicking on or hovering over the respective pull-down tab.

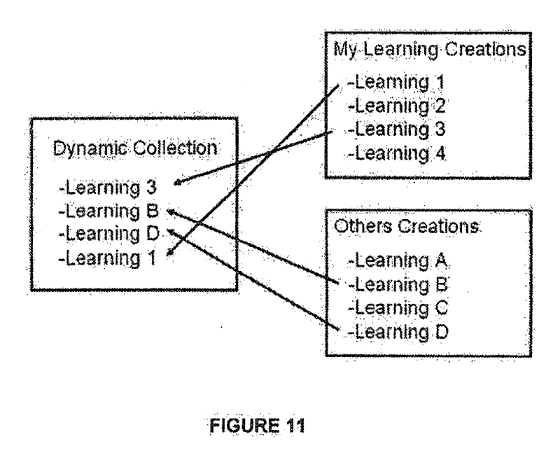

FIG. 11 shows how a user may create a NanoList, which is a collection of these learning format media objects. A NanoList collection may contain none, one, or many learning objects created by the user, and none, one, or many learning objects created by other users. The user may change the order of the learning media Objects at any time.

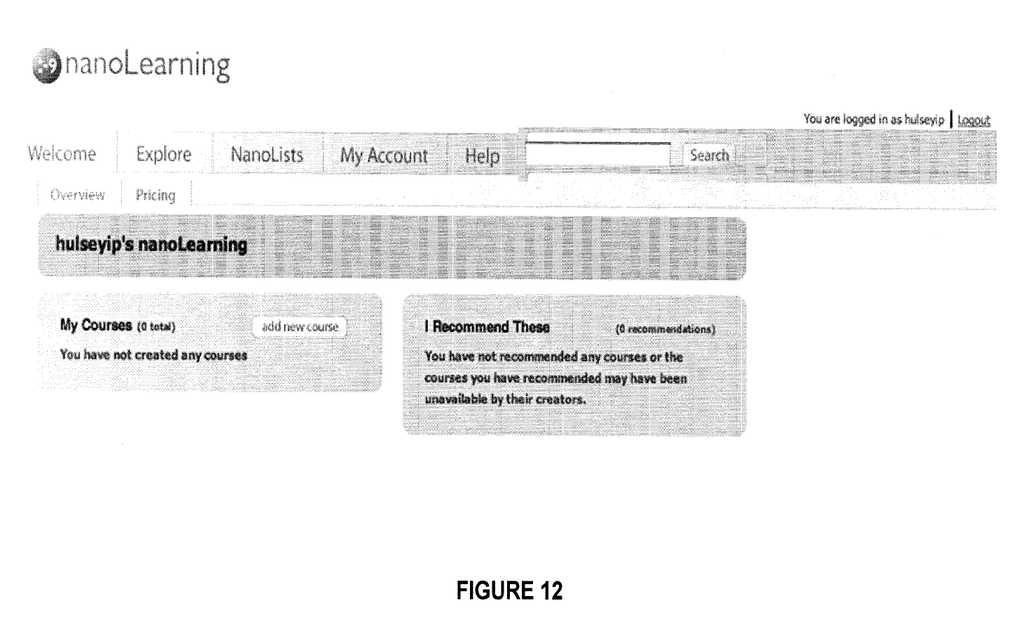

FIG. 12 depicts the flow of the programming if the user accesses the welcome sub-tabs. The user is presented with an overview and pricing tab. Below these tabs are dialogue boxes depicting total number of courses created by the user and any recommendations that they might have made. The pricing sub-tab (not shown) provides the user with a listing membership levels and the options provided to the user by each.

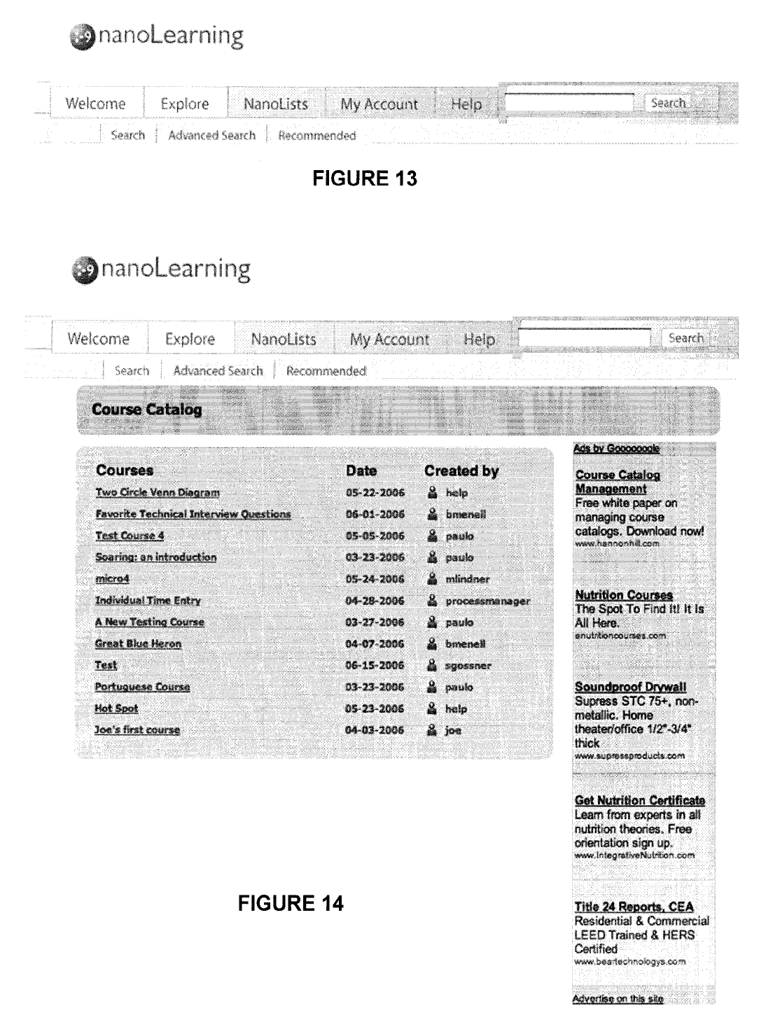

FIG. 13 illustrates the action that takes place if the user selects the explore tab. The explore tab, once selected provides the user with a Search, Advanced Search and Recommended sub-tabs. The Search tab, as illustrated in FIG. 14, shows courses available, the date of the course and who created it. An additional aspect of the present disclosure also provides the user with the access granted by the creator of the content.

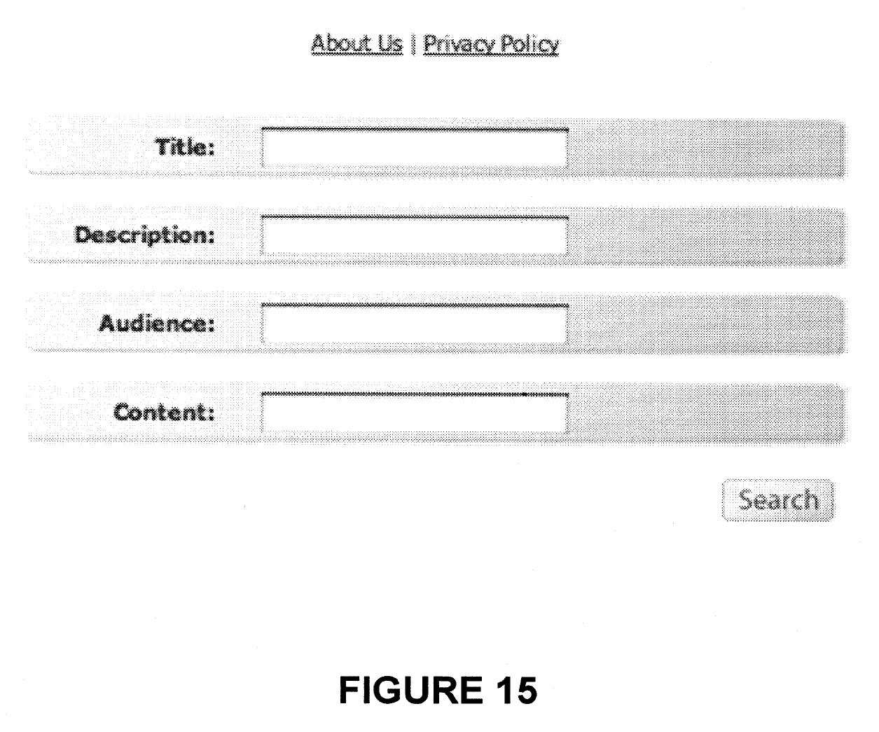

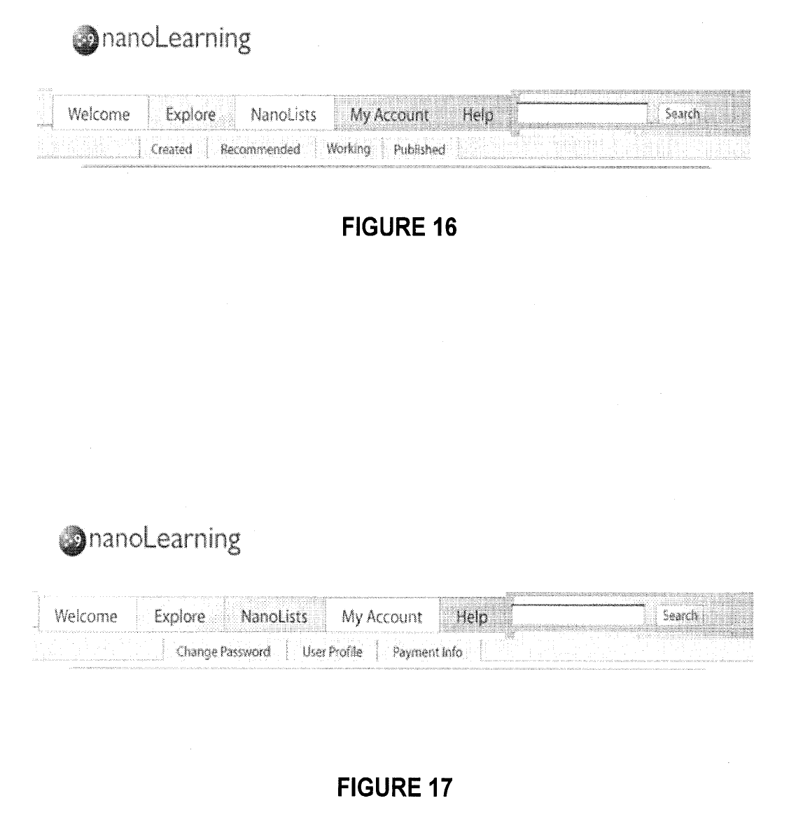

FIG. 15 depicts the advance search sub-tab and provides the user the ability to search for courses or presentations, lists etc. by entering search parameters in the respective dialogue boxes. FIG. 16 depicts the nanolist tab and its sub-tabs of created, recommended, working and published. Each provides the user lists of courses or presentations related to the respective sub-tabs.

FIG. 17 depicts the My Account tab and its associated sub-tabs of Change Password, User Profile and Payment Info.

The programs, software engines, software subroutines, wizards, operating system, etc. are run and reside at least partially on a server, comprising one or more CPU's with storage and memory and will be described with more specificity in conjunction with FIG. 18.

FIG. 18 is a block diagram of the hardware and operating environment in which different embodiments of the present disclosure may be practiced. FIG. 18 provides an overview of computer hardware and a suitable computing environment in conjunction with which one or more embodiments of the present disclosure may be implemented. Embodiments are described in terms of a computer executing computer-executable instructions. However, some embodiments may be implemented entirely in computer hardware in which the computer-executable instructions are implemented in read-only memory. Some embodiments may also be implemented in client/server computing environments where remote devices that perform tasks are linked through a communications network. Program modules may be located in both local and remote memory storage devices in a distributed computing environment.

In FIG. 18, the computing system is only one example of a suitable computing environment and is not intended to suggest any limitation as to the scope of use or functionality of the disclosure. Neither should the computing system be interpreted as having any dependency or requirement relating to any one or combination of components illustrated in the exemplary operating computing system.

With reference to FIG. 18, an exemplary system within a computing environment for implementing the disclosure includes a general purpose computing device in the form of a computing system, commercially available from Intel, IBM, AMD, Motorola, Cyrix and others. Components of the computing system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures.

Computing system typically includes a variety of computer readable media. Computer readable media may be any available media that may be accessed by the computing system and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the computing system.

The system memory includes computer storage media in the form of volatile and/or nonvolatile memory such as read-only memory (ROM) and random access memory (RAM). A basic input/output system (BIOS), containing the basic routines that help to transfer information between elements within computing system, such as during start-up, is typically stored in ROM. RAM typically contains data and/or program modules that are immediately accessible to and/or presently being operated on by processing unit. By way of example, and not limitation, FIG. 2 illustrates operating system, application programs, other program modules and program data.

Computing system may also include other removable/non-removable, volatile/nonvolatile computer storage media. By way of example only, FIG. 18 illustrates a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface such as interface, and magnetic disk drive and optical disk drive are typically connected to the system bus by a removable memory interface, such as interface.

The drives and their associated computer storage media, discussed above and illustrated in FIG. 18, provide storage of computer readable instructions, data structures, program modules and other data for the computing system. In FIG. 18, for example, hard disk drive is illustrated as storing operating system, application programs, other program modules and program data. Note that these components may either be the same as or different from operating system, application programs, other program modules, and program data. Operating system, application programs, other program modules, and program data are given different numbers hereto illustrates that, at a minimum, they are different copies.

A user may enter commands and information into the computing system through input devices such as a tablet, or electronic digitizer, a microphone, a keyboard, and pointing device, commonly referred to as a mouse, trackball, or touch pad. These and other input devices are often connected to the processing unit through a user input interface that is coupled to the system bus, but may be connected by other interface and bus structures, such as a parallel port, game port or a universal serial bus (USB).

A monitor or other type of display device is also connected to the system bus via an interface, such as a video interface. The monitor may also be integrated with a touch-screen panel or the like. Note that the monitor and/or touch screen panel may be physically coupled to a housing in which the computing system is incorporated, such as in a tablet-type personal computer. In addition, computers such as the computing system may also include other peripheral output devices such as speakers and printer, which may be connected through an output peripheral interface or the like.

Computing system may operate in a networked environment using logical connections to one or more remote computers, such as a remote computing system. The remote computing system may be a personal computer, a server, a router, a network PC, a peer device or other common network node, and typically includes many or all of the elements described above relative to the computing system, although only a memory storage device has been illustrated in FIG. 18. The logical connections depicted in FIG. 18 include a local area network (LAN) connecting through network interface and a wide area network (WAN) connecting via modem, but may also include other networks. Such networking environments are commonplace in offices, enterprise-wide computer networks, intranets and the Internet. For example, in the present embodiment, the computer system may comprise the source machine from which data is being migrated, and the remote computing system may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present disclosure. The operating system or systems may reside at a central location or distributed locations (i.e. mirrored or stand-alone).

Software programs or modules instruct the operating systems to perform tasks such as, but not limited to, facilitating client requests, system maintenance, security, data storage, data backup, data mining, document report generation and algorithms. The provided functionality may be embodied directly in hardware, in a software module executed by a processor or in any combination of the two. Furthermore, software operations may be executed, in part or wholly, by one or more servers or a client's system, via hardware, software module or any combination of the two.

A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor may read information from, and write information to, the storage medium. In the alternative, the storage medium may be integral to the processor. The processor and the storage medium may also reside in an ASIC.

The bus may be an optical or convention bus operating pursuant to various protocols that are well known in the art.

The foregoing description of the preferred embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for creating learning media, comprising:
providing a graphical user interface, said graphical user interface used for receiving user content;
receiving user content from a user;
separating user content into user content data and user content metadata;
creating learning media using a software engine and a template; and
publishing said learning media,
wherein said user content metadata provides the context for said user content data and is interpreted by said software engine to determine where various components are to be positioned in said learning media based on pre-programmed learning media format information included in said template.
